(19) United States
(12) Patent Application Publication
(10) Pub. No.: US 2009/0040579 A1
(43) Pub. Date: Feb. 12, 2009

(54) Submicron Structures In Dye-Doped Polymer Materials

(76) Inventors: Alan R. Mickelson, Boulder, CO (US); Edward M. McKenna, JR., Boulder, CO (US)

Correspondence Address: LATHROP & GAGE LC, 4845 PEARL EAST CIRCLE, SUITE 300, BOULDER, CO, 80301, US

(21) Appl. No.: 12/188,050

(22) Filed: Aug. 7, 2008

Related U.S. Application Data
(60) Provisional application No. 60/954,411, filed on Aug. 7, 2007.
(60) Provisional application No. 60/954,377, filed on Aug. 7, 2007.

(51) Int. Cl. G02B 5/32; G02B 6/00

(52) U.S. Cl. 359/15; 385/122

(57) ABSTRACT

A nonlinear dye-doped polymer optical rectification detector has an optical input for receiving a modulated optical carrier signal, an optical structure for conveying the modulated optical carrier through the detector, and an electrical structure overlaid with the optical structure arranged to optimize matching between electrical and optical waves and to enhance the second order nonlinearity of polymer in the detector. A planar waveguide fabrication method deposits a thin dye-doped polymer film onto a substrate, photobleaches one or more waveguides into the thin dye-doped polymer film, anneals the one or more waveguides to relieve stresses induced during the photobleaching process, and then forms endfaces by cleaving the substrate.

### RELATED APPLICATIONS

This application claims priority to U.S. Provisional Application Ser. No. 60/954,411 (hereinafter “'411 provisional”), filed 7 Aug. 2007, and U.S. Provisional Application No. 60/954,377 (hereinafter “'377 provisional”), filed 7 Aug. 2007, both of which are incorporated herein by reference.

### BACKGROUND

The millimeter wave regime offers a broad spectrum of frequencies in which compact antenna arrays can be used to pencil beams from point to point. Absorptive spectral features allow one the freedom to use bands that do not “leak” significantly from the path, whereas broad windows permit one to use electronic steering to selectively broadcast long distances at minimal power. High frequency radars can exhibit exquisite target discrimination. Millimeter wave feedlines are a problem. The short wavelength causes metal loss to be severe over lengths which are fixed by necessity rather than fixed at a given number of wavelengths. Signal dispersion is severe and becomes more so with ever increasing frequency. Optical feed and read-outs are options. Optical modulation technology is ever improving; however, optical detection is more problematic. Frequency responses for the highest speed photodetectors presently commercially available have a maximum response near a frequency of 50 GHz, the 3 dB bandwidth is less than 10 GHz. A detector designed for a 40 GHz passband has a response that falls off rapidly beyond that value. There have been experiments that have demonstrated responses at still higher frequencies, but none of these higher frequency responses have been realized commercially. A solution that can be scaled with frequency is needed.

Further, the drive to make integrated optical devices such as detectors, modulators, delay lines and wavelength shifters both smaller and more efficient is guiding research efforts towards making materials with larger nonlinearities and lower loss. While leading to innovations in materials research, another route to improving device efficiency and miniaturization remains relatively unexplored: the use of integrated optical slow light structures. While scale reduction is possible with slow light structures, the increased interaction time in the medium leaves questions concerning the efficiency of this approach.

### SUMMARY

In an embodiment, a nonlinear dye-doped polymer optical rectification detector includes an optical input for receiving a modulated optical carrier signal, an optical structure for conveying the modulated optical carrier through the detector, and electrical structure overlaid with the optical structure arranged to optimize matching between electrical and optical waves and to enhance the second order nonlinearity of polymer in the detector.

In another embodiment, a method manufactures a dye-doped polymer optical rectification detector. A cladding layer is formed on a substrate and a nonlinear polymer layer is formed on the cladding layer. Waveguides are photobleached into the polymer layer and then annealed to relieve stress in the nonlinear polymer layer. A top cladding layer is formed onto the nonlinear polymer layer and a metal layer is deposited onto the top cladding layer. Coplanar waveguides are etched into the metal layer. The optical rectification detector is heated and a poling voltage is applied to electrodes formed on the metal layer for a period determined by monitoring a poling current. Waveguide endfaces are formed for interfacing to an optical carrier signal.

In another embodiment, a method reduces the group velocity of light in a dye-doped polymer optical rectification detector. A Bragg grating is holographically written into one or more waveguides of the detector, and a super period is holographically written into the waveguides using irreversible photobleaching to form a Moiré grating. The polymer of the detector is annealed in-situ to reduce stresses induced from altering the submicron structure of the grating.

In another embodiment, a planar waveguide fabrication method deposits a thin dye-doped polymer film onto a substrate, photobleaches one or more waveguides into the thin dye-doped polymer film, anneals the one or more waveguides to relieve stresses induced during the photobleaching process, and forms endfaces by cleaving the substrate.

### BRIEF DESCRIPTION OF THE FIGURES

FIG. 1A shows a traveling wave structure.

FIG. 1B shows a cross section of the active region of the traveling wave structure of FIG. 1A.

FIG. 2A shows a top perspective view of a dye-doped polymer optical rectification detector (ORD), in an embodiment.

FIG. 2B shows a cross section of the active region of dye-doped polymer ORD of FIG. 2A.

FIG. 3 is a graph illustrating a comparison of the calculated frequency response of ideal ORDs with that of a commercial available ORD.

FIG. 4 is a flowchart illustrating one exemplary method for planar waveguide fabrication, in an embodiment.

FIG. 5 shows one exemplary setup for bleaching waveguides in PMMA/DR1 and Ultem/DEDR1.

FIG. 6 is a flowchart illustrating one exemplary method for slow light grating fabrication, in an embodiment.

FIG. 7 shows one exemplary holographic photobleaching setup for creating Bragg gratings, in an embodiment.

FIG. 8 shows one exemplary setup for photobleaching the super period gratings, in an embodiment.

FIG. 9 shows one exemplary interference pattern used to modulate the super period grating in dye-doped polymer waveguide.

### DETAILED DESCRIPTION OF THE FIGURES

In one aspect of this invention a dye-doped polymer Optical Rectification Detector (ORD) is described. The ORD has both an electrical and an optical structure that optimizes the matching between the electrical and optical waves and also enhances the second order nonlinearity of the material. The described ORD is optimized for optical rectification in the lower frequency regime (e.g., microwave/millimeter wave), a frequency regime that is very important in practice. Slowing structures are introduced to further enhance the capabilities of ORDs and other devices.

In an embodiment, a submicron structure for slowing the group velocity of light in nonlinear high Tg dye-doped polymer materials is also disclosed along with a fabrication technique developed to relieve stresses in the dye-doped polymer during the formation of submicron structures in the material. These stresses have been experimentally observed to cause the failure of planar diffraction gratings and waveguide deformation in dye-doped polymer films and have posed a major obstacle to photobleaching submicron structures.

Models and fabrication techniques necessary to create submicron structures in dye-doped polymer waveguide materials are described herein with the more specific goal of creating Moiré gratings that are slow light structures capable of reducing the group velocity of light in a medium many times smaller than that of the index itself. The ability to fabricate Moiré gratings in dye-doped polymers presents a pathway to enhancing material nonlinearities and opens up a class of miniature optical delay line components with diverse dispersion characteristics. In order to achieve the goal, investigations into the photobleaching process were made, resulting in new phenomenological insights and models of the irreversible photobleaching process.

It is demonstrated that electro-optic polymers are an enabling technology for certain integrated optical structures, with a focus on producing better performing optical devices that are fabricated in organic rather than inorganic material. The optical devices described herein showcase the adaptability of designer polymers in optical device fabrication.

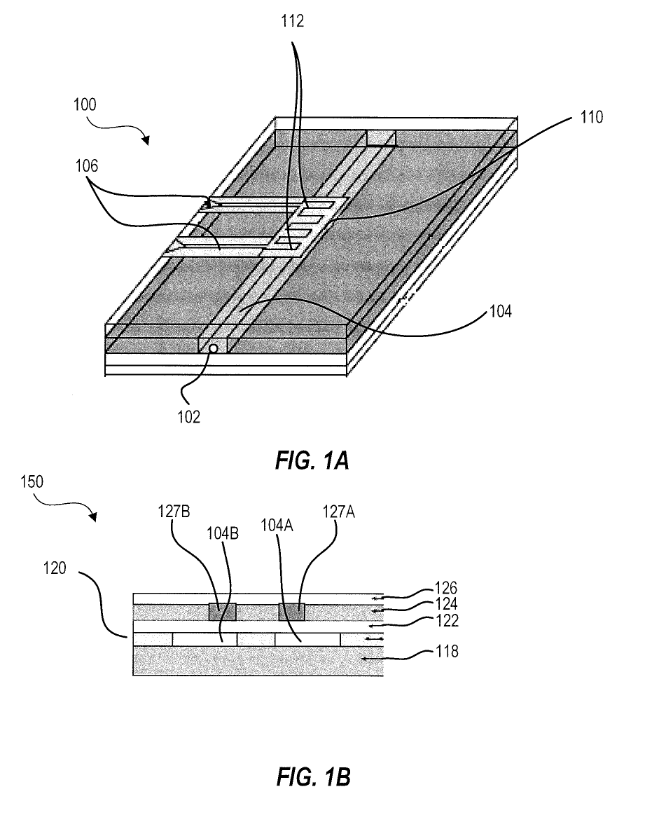

FIG. 1A shows an archetypical traveling wave structure 100. Structure 100 has an optical input 102 to receive light from an external guide (e.g., an optical fiber) into a waveguide structure 104. An electrode structure 106 of, for example, Au coplanar traveling wave electrodes, is overlaid onto waveguide structure 104. Traveling wave structure 100 matches a slow group velocity light wave of a slow wave region 110 with a slow phase velocity electrical wave of a slow wave electrical region 112. The slow optical group velocity increases the optical intensity and thus increases the nonlinear interaction in the overlap region. The slow phase velocity electrical wave allows for a longer interaction region (in tenns of electrical waves). The result is the square of the slowing factor increase in sensitivity of the structure as an ORD. With optical rectification, this increased sensitivity is important at low modulation frequency.

In traveling wave structure 100 there is no need for a voltage bias as the electro-optic medium itself induces charge motion in electrodes 106. That is, an electro-optic medium is endowed with a DC dipole moment. In one example of operation, an optical wave enters optical input 102, propagates through waveguide structure 104 altering the dipole structure, and changes the distribution of charge in the medium and thereby on electrodes 106. A time varying intensity induces a time varying charge (i.e., current) on electrodes 106. If the phase velocity of the current matches the group velocity, that is, the propagation velocity of the disturbance generating it, then the current will increase with propagation length.

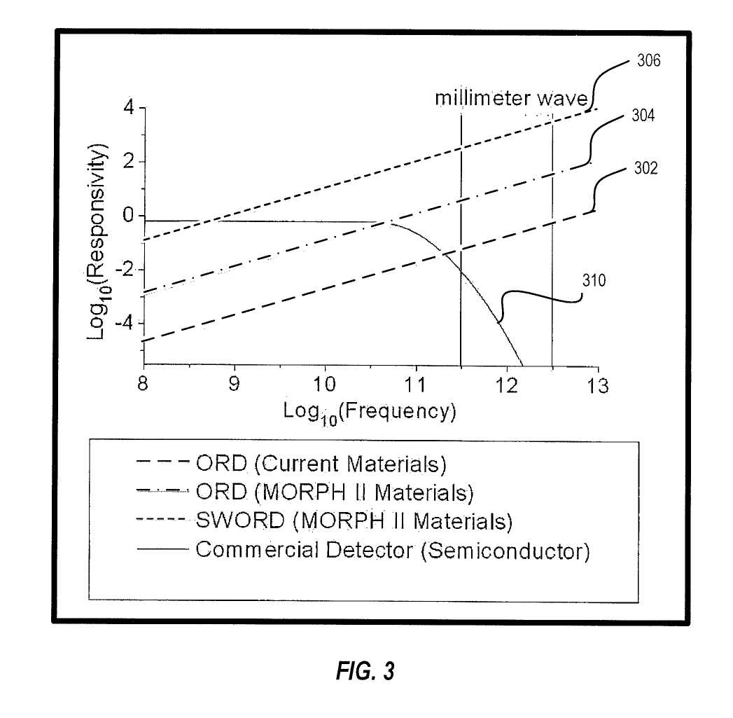

The effect is linearly proportional to the time rate of change of the intensity and the electro-optic coefficient (see FIG. 3). It is a strong effect in the THz frequency range and may be made stronger in the microwave/millimeter wave by increasing the optical intensity. Slowing the group velocity of the optical wave is a technique to increase the optical intensity.

In the frequency regime, there is a greater degree of control over the shape of the dispersion curve between the two resonant frequencies. This effect is proposed as a method for producing a slow wave frequency regime in an optical fiber in which two coherent gratings have been written. Such structures have been produced in electro-optic polymers. A slow phase velocity frequency regime occurs directly below the resonant frequency of an electromagnetic structure which periodically perturbs the group velocity of a propagating electromagnetic wave. This may be exploited to produce a slow phase velocity coplanar waveguide structure. Such a structure may be matched to the slow group velocity regime in an electro-optic polymer.

The current induced in electrodes 106 of structure 100 is given by

$$i ( t ) = \frac{d q ( t )}{d t} = \frac{d}{d t} [ α {\int }_{A} {P}_{NL} \cdot d A ] \approx \frac{α {An}^{3} {r}_{33}}{2 c} \frac{d {I}_{opt} ( t )}{d t} \qquad ( 1 )$$

where α is an overlap factor, A the area enclosed by the charge in the electro-optic medium, n the index of refraction of the medium, r33 the electro-optic coefficient, c the speed of light, and Iₒₚₜ the optical intensity in the medium. The detected current varies linearly with the nonlinear coefficient, optical intensity and frequency of modulation of the optical intensity as was previously mentioned.

The properties of wave propagation in coherently recorded multiple periodicity media become quite interesting in the limit where the grating periodicities are so close together such that the upper slow wave regime of the lower frequency grating overlaps the lower slow wave grating of the higher frequency grating. The index of refraction n(z) of a medium whose index has been modulated by a coherent two beam holographic pattern and then poled could be of the form

n(z)=n₀+Δn(V)[cos κ₁z+cos κ₂z] (2)

where n is the index of the unperturbed medium, z is the index contrast, assumed to be the same for both periodicities and also assumed to be dependent on any voltage V applied across the grating in order to augment the index contrast through the electrooptic effect, κ₁ and κ₂ are the wave numbers of the coherently written gratings which can be defined in terms of their resonant frequencies ω₁ and ω₂ by κ₁=cω₁/n₀ and κ₂=cω₂/n₀ where c is the free space speed of light and z is the propagation coordinate. The phase velocity vₚ of a wave is the wave's frequency ω divided by the wave's propagation constant k such that vₚ=ω/k and its group velocity is the change of its frequency with wave number such that v_{g}=dω/dk. If Δn(V) were (roughly) zero and if the wavelength dependence of n is small (quite reasonably for materials in question), then the group velocity in the frequency regime between the resonant frequencies of the two grating periodicities will be approximately equal to the phase velocity given by

$${v}_{g} \approx \frac{Δ ω}{Δ κ} \approx c / {n}_{0} , \qquad ( 3 )$$

where the relations Δω=ω₂−ω₁ is the (positive) difference between the resonant frequencies and Δκ=κ₂−κ₁=cΔω/n₀ as a definition. When the perturbation is applied, however, the frequency range between the “gap” regions is compressed by the frequency extent of the gap regions and we obtain the relation that

$${v}_{g } \approx ( \frac{c}{{n}_{0}} ) [ 1 - ( \frac{Δ n ( V )}{8} ) ( \frac{{κ}_{2} + {κ}_{1}}{{κ}_{2} - {κ}_{1}} ) ] . \qquad eq 4$$

FIG. 1B shows a cross section 150 of an active region of traveling wave structure 100. Wave structure 100 is created by evaporating a Tungten/gold layer 120 onto a quartz substrate 118. Waveguides 104A and 104B are formed during this process. A polymethylmethacrylate (PMMA) cladding layer 122 is spun onto Tungsten/gold layer 120 at 500 rpm and baked for 3 hours at 80 degrees Celcious (C). A PMMA/DCM layer 124 is then spun on at 650 rpm and baked for 3 hours at 80 degrees C. Coplanar waveguides 127A and 127B are then formed. PMMA cladding layer 126 is then spun on in similar fashion to cladding layer 122. The current induced in electrodes 106 in this cross section is phase matched to the optical wave so that the two waves continue to induce current as they propagate down the structure in the direction perpendicular to the page.

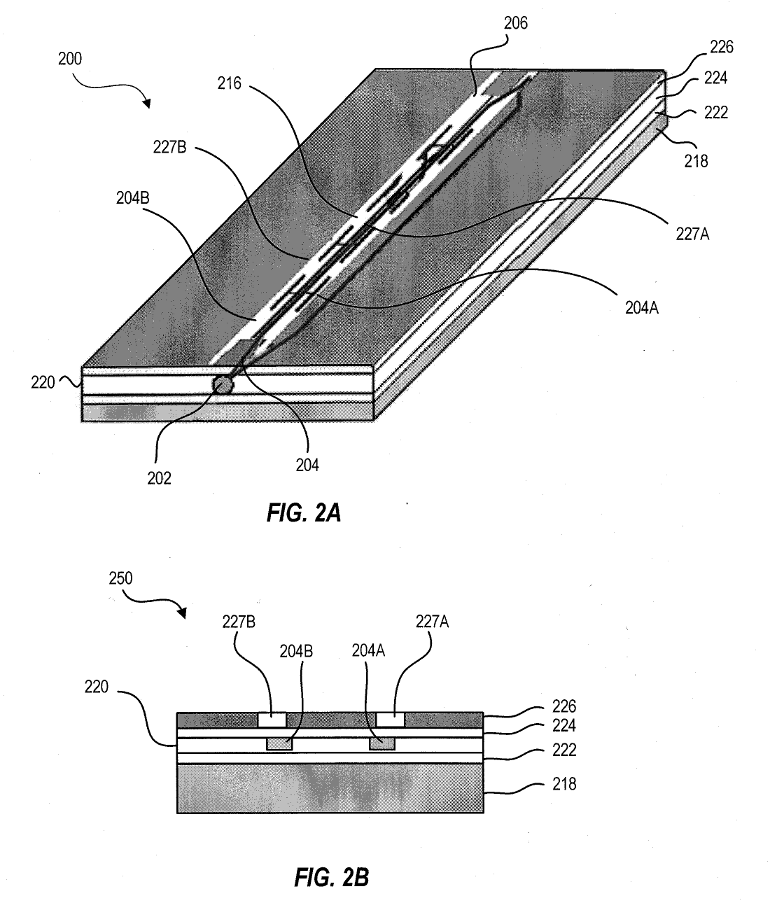

FIG. 2A shows a top perspective view of one exemplary dye-doped polymer ORD 200. FIG. 2B shows a cross section 250 of the active region of dye-doped polymer ORD 200 of FIG. 2A. FIGS. 2A and 2B are best viewed together with the following description. ORD 200 is, for example, an integrated 1550 nm slow wave detector with low loss and high r33. ORD 200 has straight coplanar electrodes 206 and a straight optical channel 204. In ORD 200, electrical structure (i.e., electrodes 206) is placed underneath the optical structure (i.e., optical channel 204). This change has no effect on the basic operation of ORD 200; however, it does provide for ease in the fabrication process and may lead to better overlap between the optical and electrical fields. In one embodiment, electrodes 206 are Au coplanar traveling wave electrodes. Optical channel 204 is in an active polymer layer that is buffered on the top with a cladding layer 224 and on the bottom with a cladding layer 222. Modulation of the optical intensity passing through the structure induces currents in electrodes 206. Slow wave optical channel 204 carries the optical wave and slow wave electrical line 216 carries the electrical signal.

High-speed signals may be extracted from a modulated optical carrier using a second order nonlinearity to generate a photogenerated dipole that oscillates at a modulation frequency. This process is known as optical rectification. The generated dipole may be coupled to a transmission line and thus the modulation signal may be turned into an electrical signal. This technique is advantageous in high frequency applications because the detection bandwidth is not limited by the response of charge carriers in a medium, as in the case of semiconducting photodetectors. The detector efficiency also increases as the frequency of the signal increases. Since photons do not generate charge carriers, the responsivity of the device may be greater than one. However, a drawback to this technique is that the efficiency of ORD 200 is a function of matching the phase velocity of the electrical signal on the electrodes to the group velocity of the optical signal.

Dye doped polymer materials are ideal for forming integrated optical devices, since these materials may be spun onto a substrate 220 and photobleached to create device structures. The dye-doped polymer materials may also be poled to create a noncentrosymmetric material with a second order nonlinearity. In one embodiment, ORD 200 is created by spinning a cladding layer 222 onto a quartz substrate 218. A nonlinear polymer layer 220 is then spun onto cladding layer 222. Channel waveguides 204A and 204B are photobleached into polymer layer 220 in a Mach-Zhender configuration (ORD 200 is virtually an inverse Mach-Zhender). A top cladding layer 224 is then spun onto polymer layer 220. Cladding layers 224 and 222 may be formed of polymethylmethacrylate (PMMA). A metal layer 226 is deposited on top of cladding layer 224 and coplanar waveguides (CPW) 227A and 227B are etched into metal layer 226.

ORD 200 is then heated and a poling voltage is applied to electrodes 206. The poling current is monitored to determine the completion of the poling process. The current induced in the electrodes is phase matched to the optical wave so that the two waves continue to induce current as they propagate down the structure in the direction perpendicular to the page in the cross section of FIG. 2B.

The structure of ORD 200 is essentially identical to that of an optical modulator. The optical waveguide configuration in FIG. 2A is masked by electrodes 206; therefore, it is not clear if the modulator is a phase modulator, a directional coupler modulator intensity modulator or an interferometric intensity modulator. The operation of ORD 200 is essentially inverse of that of a two-output interferometric intensity modulator. Not taking to account electrode loss, the modulator/detector is lossless device and, therefore, would be inherently reversible and the inverse relation is exact. Even taking into account electrode loss, the inverse is close to being such. In practice, the difference between ORD 200 and a one input two-output modulator is the feedline. A modulator requires an input feedline that often must be accompanied (through a bias tee) with a bias voltage and an output coupling to a matched load resistance. As a detector, however, ORD 200 structure requires no applied voltage or input feedline. ORD 200 requires only an output coupling structure to transmit the received millimeter signal to the intended processing location. In contrast, current photovoltaic detectors require input bias as well as output coupling.

Grating structures may be used in ORD 200 to further slow the group velocity of the optical wave (see FIG. 3). A periodic slow wave structure in electrodes 206 may be used to match the phase velocity on electrodes 206 to the group velocity of the optical wave in optical channel 204 and thereby increase both the effective interaction length and the optical intensity to boost the transduction efficiency from optical intensity modulation to electrical traveling wave. By way of example, a periodic slow wave structure such as Moiré gratings may be introduced into coplanar waveguides (e.g., 227A and 227B of ORD 200) such that the coplanar waveguides become slow wave structures.

FIG. 3 is a graph illustrating a comparison of the calculated frequency response of ideal ORDs (e.g., ORD 200, FIGS. 2A and 2B) with that of a 40 GHz Discovery Semiconductor detector (the widest bandwidth commercial ORD currently available). Optical rectification is already the standard technique for generation of THz radiation. Microwave operation and linear increase of responsivity with the rate of microwave modulation is demonstrated below and thus the viability of optical rectification as a detection technique.

A 40 GHz photovoltaic Discovery photodetector trace 310 is compared with three ideal parameterized ORDs. The ideal ORDs show the theoretical responsivity curves for ORDs fabricated with different materials and structures. Line 302 represents the reponsivity of an ORD made with an electro-optic (r) coefficient equal to that of lithium niobate. Line 304 represents the responsivity of an ORD with an r coefficient (600 pM/V) of a MORPH II material. Line 306 assumes another enhancement factor due to either light slowing or an increased r coefficient of later MORPH phases. The most salient feature of the ORD frequency responses is the linearly increasing sensitivity or responsivity (y-axis) with increasing intensity modulation frequency (x-axis). This linearity is the reason why optical rectification is the choice for conversion of femtosecond laser pulses to terahertz (THz) carriers. The theoretical linearly increasing response scales with the factor

$${r}_{eff} = \frac{ro}{{s}^{2}} \qquad Eq . 1$$

where r_{eff} is the effective electro-optic coefficient, r is the actual electro-optic coefficient of the material, o is an overlap factor between the optical and millimeter wave fields and s is a slowing factor. The maximum r of, for example, lithium niobate is 30 pM/V. MORPH phase II materials will have an r of 600 pM/V. The best possible overlaps are of the order of 0.6.

Slowing of the group velocity of optical waves has not been demonstrated definitively in polymers. In Bose Einstein condensates (BECs), s's of 107 have been achieved. Phase velocity slowing of millimeter waves of 5 have been demonstrated.

The three plots of FIG. 3 are for an ORD made from today's best electrooptic polymers (MORPH phase II material). One of the plots is made from MORPH phase II material and one made from MORPH phase II material constructed with a slowing factor of 10. MORPH III materials without slowing would lie between the MORPH II curve and the slowed MORPH II curve.

Realistically, there is a problem with realizing the full advantage of the increased sensitivity in this traveling wave structure due to the ever-increasing value of the conductor loss with frequency. Such conductor loss is often a problem with any design that transduces a guided millimeter wave.

Another salient feature of the ORD (e.g., ORD 200, FIG. 2A) is that it may exhibit a conversion efficiency of greater than one electron per photon at higher frequencies of operation. The conversion mechanism is not a quantum conversion but rather a collective conversion much like the conversion of field to current in an antenna. Metal loss may also make this “greater than unity” effect hard to observe. Even with caveats, though, it is seen that with MORPH phase II materials, the ORD's responsivity should match today's best detectors at a frequency of roughly 40 GHz and exceed that efficiency for higher modulation rates. By additionally slowing the waves without losing the match of optical group velocity with millimeter wave phase velocity, the crossover point shifts all the way down into the RF regime (i.e., below 1 GHz). With the increased r coefficient of MORPH III materials, even without slowing, the crossover point shifts to lower frequencies and efficiency continues to increase linearly with increasing frequency.

Structures that reduce the group velocity of light in a medium are commonly referred to as “Slow light structures.” As discussed above an ORD (e.g., ORD 200, FIG. 2A), and indeed other structures, may be improved by introducing such light slowing structures. Integrated optical slow light structures reduce the group velocity of an optical signal to increase the interaction time, enhance existing nonlinearities and, in principle, reduce the scale of integrated optical devices. While scale reduction is possible with slow light structures, the increased interaction time in the medium leaves questions concerning the efficiency of this approach. The increased interaction time between an optical wave and the nonlinear medium it propagates in enhance the resulting nonlinear interaction. However, increasing the interaction time in a medium may increase the scattering and absorption losses which could make the gains due to slowing irrelevant.

A submicron structure is described below for slowing the group velocity of light in nonlinear high Tg dye-doped polymer materials. The processing steps necessary to generate the structure are also illustrated. The ideal platform for exploring the effect of slow light should be a nonlinear material that has low optical loss and can be easily manipulated to form slow light structures. Dye-doped polymer waveguides materials offer the ideal platform to explore the effects of slow light in Moiré gratings. Dye-doped polymer materials can be spun onto substrates in layers to form the transverse makeup of devices, while devices structures such as waveguides can be written into various layers using the process of irreversible photobleaching. Second order nonlinearities can be introduced into the dye-doped polymer devices through the process of poling. Polymer materials can have low scattering and absorption losses in the range of 0.1 dB/cm.

Slow light has been demonstrated using numerous techniques and offers the possibility of manufacturing new and improved integrated optical components from miniaturized true optical time delay elements to efficient nonlinear integrated optical components. Dye-doped polymer materials offer an ideal medium to investigate the benefits of slow light propagation. Nonlinear integrated optical devices can be fabricated in dye-doped polymer materials using irreversible photobleaching and the materials are relatively low loss. Where improved nonlinear efficiencies may be realized using slow light structures, this may offer an alternative route to more efficient nonlinear devices as opposed to the present research efforts toward material synthesis.

As mentioned above, one slow light structure that is fabricated in dye-doped polymer materials using the process of irreversible photobleaching is a Moirégrating. A Moiré grating may be generated by holographically writing a Bragg grating into a dye-doped polymer waveguide and then modulating the amplitude of the index change of the Bragg grating with a second periodic structure with a much larger period. The second periodic structure is commonly referred to as a super-period. The second periodic structure may also be written into the waveguide using holographic techniques. This work focuses on the models and fabrication techniques necessary to make Moiré gratings in dye-doped polymer waveguides. A new photobleaching model is introduced that simplifies the radiative rate equations by modeling the absorption spectrum of dye-doped polymer materials with Gaussian absorption features. Two of the absorption features that describe states of the dye molecule are dynamically coupled through the radiation field using two parameters. One parameter describes the photobleaching rate and the other describes the coupling between the two states.

The model was demonstrated with two different guest-host systems, DCM/BCB and DCM/PFCB. It was also expanded to model the change in absorption of the system at the photobleaching wavelength. The model is directly applicable to standard photobleaching setups that don't use other techniques to monitor the absorption spectrum of the film. Moiré gratings are demonstrated for the first time in DH6/APC and PMMA/DR1 channel waveguides. These gratings are holographically written into the waveguides using irreversible photobleaching and in situ annealing of the film. The annealing of the film is an important and unique part of the process that prevents stresses induced in the material from altering the submicron structure of the gratings. Slowing factors of 1.25 to 2.6 are extracted from the reflectance spectrum of the two guides. The slowing factors for the gratings are compared to theoretical models.

The slow light Moiré structures in dye-doped polymer materials enhance the nonlinearity of materials and offer a true time delay element as well. Such a small integrated optical device has applications for improving the efficiency of polymer electro-optic modulators, polymer based OPOs, time-delay elements in fiber optic communications systems, a new class of high speed detectors based on optical rectification . . . etc. The only competing technology is that of photonic crystals and coupled resonator devices, but at present the devices have extremely high loss.

The reduction of the group velocity of an optical wave in a material increases the interaction time of a wave. If the slow light structure is written into a nonlinear medium the nonlinearities are enhanced due to the increased interaction time. For nonlinear dye-doped polymer materials this enhancement has broad applicability. Enhancing the nonlinearity reduces the switching voltage of polymer electro-optic modulators, generates more efficient optical parametric oscillators (OPO), and enhances the detection efficiency of polymer ORD's.

Moiré gratings are Bragg gratings that have their index distribution modulated by a second periodic structure with a period that is generally much larger than that of the Bragg grating itself. The large period is often referred to as the super-period of the grating. The index distribution for a Moiré grating is given by,

$$n ( x ) = {n}_{0} + Δ n \cdot cos ( \frac{2 π}{{Λ}_{s}} x ) \cdot cos ( \frac{2 π}{{Λ}_{B}} x )$$

where Δn is the index change, λ_{S} is the super-period, and λ_{B} is the Bragg grating period. The Moiré grating can reduce the group velocity of the optical wave significantly below that of the optical wave traveling through the medium itself. The ratio of the group velocity of an optical wave in the medium without the structure to the group velocity in the medium with the structure is called the slowing factor S. It has been shown that the slowing factor for a Moiré grating is given by,

$$S = \frac{sin h ( π σ )}{π σ}$$

where σ is given by,

$$σ = \frac{Δ n {Λ}_{s}}{4 {n}_{0} {Λ}_{B}}$$

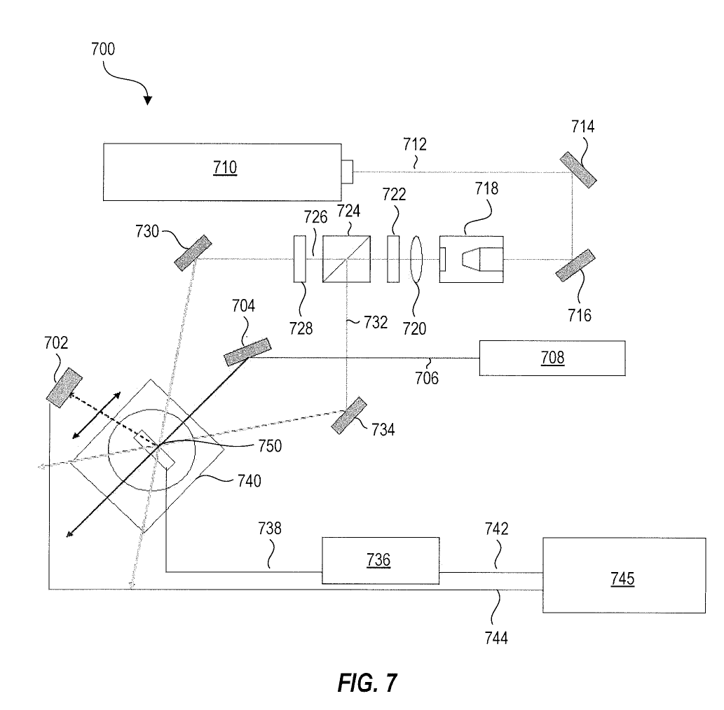

Writing Moiré gratings into high Tg dye-doped polymer channel waveguides is described in more detail below (see FIG. 7). The process uses an argon ion laser to holographically write the Bragg grating using the process of irreversible photobleaching. The super-period for the structure is then holographically written into the material containing the Bragg grating this forms the Moiré grating. The precise control of the index change needed for the formation of Moiré gratings is accomplished using photobleaching models. Another key aspect of this process is heating the substrate while photobleaching the gratings. The photobleaching process induces large stress in the materials that can potentially generate micro-cracks in the polymer film which in turn ruin the grating. The stresses have also been observed to deform channel waveguides that were created by photobleaching with a UV lamp.

Experimentation has demonstrated 1 cm Moiré gratings with a slowing factor of 2 in PMMAJDR1 channel waveguides. This slowing factor should increase the second order nonlinearity of poled polymer films by a factor of 2. By inscribing the structures into an arm of an electro-optic modulator the Vₚᵢ for the device is reduced by a factor of 2. References and work are found in the '411 provisional.

The fabrication techniques to construct Moiré gratings into high Tg dye-doped polymer materials have recently been demonstrated by experimentation. Without these fabrication techniques (including photobleaching models) the ability to fabricate submicron structures is not possible. Fabrication of structures in dye-doped polymer materials has shifted towards semiconductor industry processing techniques such as reactive ion etching (RIE) and electron beam lithography. There are numerous techniques for fabricating optical devices using dye-doped materials. Some of theses techniques are reactive ion etching (RIE), laser writing, poling induced writing, moulding/embossing and irreversible photobleaching. While each of these processes maybe used to generate optical devices, irreversible photobleaching is the only process that allows the index of refraction to be controlled. This process is also a natural process to use with dye-doped polymer materials because the dye molecules can be readily photobleached. Chemical etching processes such as RIE originated in the semiconductor industry and are inherently problematic for polymer material systems since most polymers aren't chemically resistant enough to withstand the processing. This requires the nonlinear polymer layers to have protective layers of epoxy and metal to be spun over them to make sure they are not damaged during device fabrication. Thus, these techniques damage polymer films and often require a sacrificial layer to protect nonlinear polymer layers in devices. The process of irreversible photobleaching is ideal for forming Moiré structures, but the stresses induced during the process may ruin the film as well. This problem is solved using the in-situ annealing process described herein.

The drive to make integrated optical devices such as modulators, delay lines and wavelength shifters smaller and more efficient is currently guiding research efforts to make materials with larger nonlinearities and lower loss. While this push is leading to innovations in materials research there is another route to improving device efficiency and miniaturization that is relatively unexplored. This unexplored route is through the use of integrated optical slow light structures. Integrated optical slow light structures are structures that reduce the group velocity of an optical signal. Reducing the group velocity of a signal increases the interaction time offering the ability to enhance existing nonlinearities which in principle should reduce the scale of integrated optical devices. While scale reduction is possible with slow light structures, the increased interaction time in the medium leaves questions concerning the efficiency of this approach. It is clear that the increased interaction time between an optical wave and the nonlinear medium it propagates in should enhance the resulting nonlinear interaction; it is unclear what occurs with undesired interactions such as scattering and absorption in the medium. Increasing the interaction time in a medium should increase the scattering and absorption losses which may make the gains due to slowing irrelevant.

While the properties of dye-doped polymer waveguide materials are ideally suited to explore the effects of slow light propagation, there are still unknown factors in the device processing. The method chosen for generating slow light in this research requires the generation of a Moiré grating in waveguide structures. These structures were chosen because they can be photobleached into dye-doped polymer materials using holographic techniques. Moiré gratings are generated by amplitude modulating a Bragg grating with a sinusoidal modulation with a much larger period. Typical dye-doped polymer waveguide materials have indices of 1.5-1.6 which means a Bragg grating period for a 1550 nm light wave will be approximately 480 nm. There is a void in the literature concerning the irreversible photobleaching of such submicron structures not to mention the effects of modulating such a fine period structure with a second structure. The results of this research will expand the use of dye-doped polymer materials. The characteristics of Moiré gratings are determined by the distribution of the index of refraction. In order to control the characteristics of the grating in dye-doped polymers, models of the irreversible photobleaching process will need to be used. The process of irreversible photobleaching changes the absorption spectrum of the dye-doped polymer materials which is directly related to the change in the index of refraction of the material. These models have been used to predict the photobleaching process for waveguides for incoherent UV radiation, but this work represents the first time a new set of models will be used to describe the photobleaching process for a coherent source for both guest-host and side-chained polymer systems. The irreversible photobleaching models describe the oscillations in the absorbance spectrum of the dye-doped polymer materials during and after the exposure process. Without the models, the control of the index necessary to form a submicron structures wouldn't be possible.

The fabrication method and utilization of Moiré gratings in dye-doped polymer materials to reduce the group velocity of light are disclosed herein. However, it is necessary to describe not only the group velocity of light, but also the numerous methods that have been described for reducing the group velocity. The review of the various methods allows a clear distinction between the advantages and disadvantages of the approach. At first glance the methods employed to reduce the group velocity of light appear to be quite different. There seems to be little relation between using cold atoms to slow light and using microring resonators to accomplish the same task, but the two systems utilize similar principles even though the physical implementation of those principles is quite different. A fundamental principle behind most of the systems is that the narrow bandlimited transmission spectra for most systems yield large group delays in the passband. The group delays are connected to the transmission spectra through the Hilbert transform.

The general principles behind the reduction of the group velocity of light in a medium are also accompanied by a set of limitations imposed by the system on the signal itself. These limitations dictate the available bandwidth for the source due to the width of the passband, the modulation bandwidth due to the increased dispersion of the medium and the signal strength due to enhanced losses in the passband from scattering and absorption.

There are numerous techniques for generating slow light systems (these techniques are described in provisional '411). For instance, EIT and coherent population trapping are material based resonance effects that rely on atoms that have a specific energy level configuration. Coupled resonator optical waveguides (CROW) and side coupled integrated spaced sequence optical resonators (SCISSOR) are two types of periodic structures that are used to guide light, as well as, to control the group velocity of the light in a medium. Stimulated Brillouin Scattering (SBS) is a nonlinear process that occurs when a high intensity pump beam generates an acoustic wave in a medium which in turn scatters the pump beam into a Stokes shifted beam. However, the focus of this work concerns the fabrication and utilization of Moirégratings in dye-doped polymer materials to reduce the group velocity of light.

Relationships for the group velocity of the system and relevant parameters will be given so that comparisons can be made to the use of Moirégratings in dye-doped polymer materials.

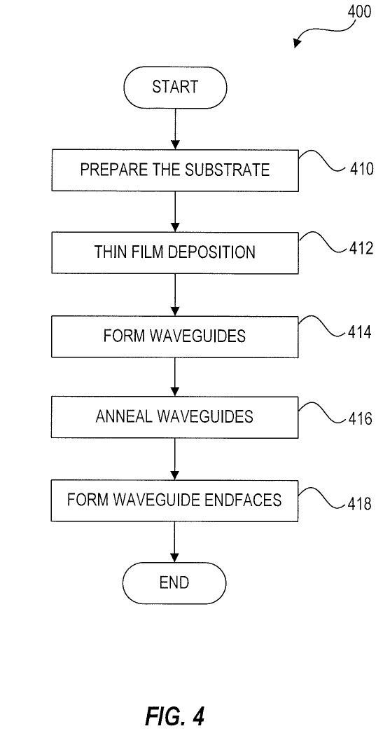

FIG. 4 is a flowchart illustrating one exemplary method 400 for planar waveguide fabrication. In step 410, method 400 prepares the substrates. In one example of step 410, glass substrates are made from pre-cleaned, one inch by three inch microscope slides that are cleaved into two pieces. First, the glass is cleaned using a 5-step process. The process may consist of a ten minute ultrasonic bath in deionized (DI) water with 3% Liquinox at 45 degrees Celsius (C). This is followed by a DI water rinse, a 10 minute ultrasonic bath in DI water at 45 degrees C., a 10 minute ultrasonic bath in methanol at 60 degrees C. and finally a 10 minute ultrasonic bath in acetone. The cleaning process may be repeated to ensure polymer film has good adhesion to the substrate in step 412. After the substrates are cleaned, they may be stored temporarily in methanol to prevent any film from forming on the glass due to the evaporation of acetone in air.

In step 412, method 400 deposits a thin polymer film onto the substrate. In one example of step 412, thin films may be generated by spinning the polymer solution onto the substrate. One exemplary film is PMMA/DR1 prepared by IBM Almaden Research Center (ARC). This film comes in a solution in dyglyme with a concentration of 22.5% by weight. The PMMA/DR1 films are then spun onto the substrates at 3000 rpm for 30 seconds to form a film that is approximately 2.5 μm thick. The films are then prebaked at 90 degrees C. for three hours and then post baked at 120 degrees C. for 17 hours. The Ultem/DEDR1 solution is also prepared by ARC and it comes as a solution in anisole with a concentration of 13.5% by weight. The Ultem/DEDR1 films are spun onto the glass substrates at 1800 RPM for 30 seconds forming a film that is 2.5 μm thick. The Ultem/DEDR1 films are then baked for 3 hours at 90 degrees C. and then post baked at 140 degrees C. for 12 hours. The film thickness may be measured using the DekTak profilometer. The spin curves for Ultem/DEDR1 and PMMA/DR1 and the relationship between film thickness and spin speed can be found in Appendix A of the '411 provisional.

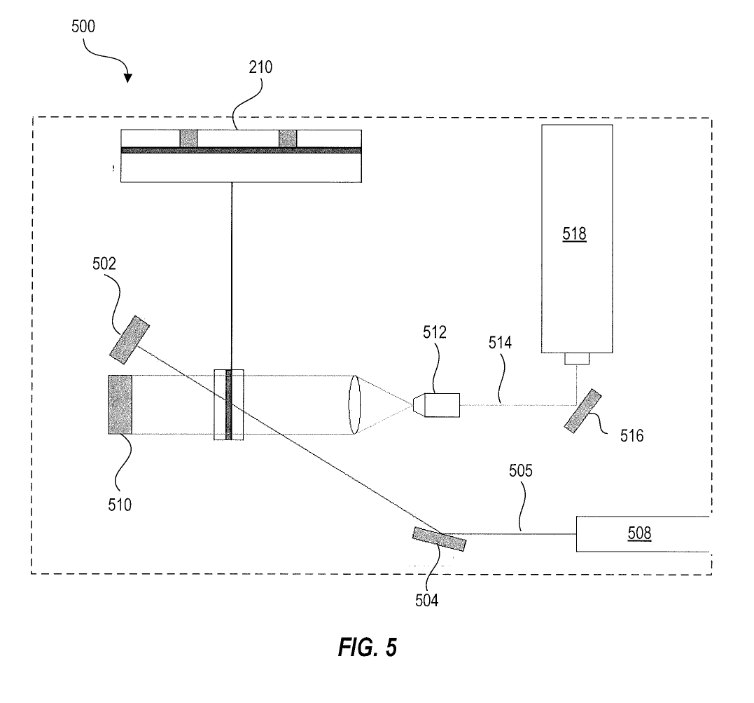

In step 414, method 400 forms waveguides are formed. In one example of step 414, after thin film deposition of step 412, waveguides are photobleached into the PMMA/DR1 and Ultem/DEDR1 films. The waveguides may be made by placing a channel waveguide contact mask over the film and exposing the film with the multiline visible radiation from a Coherent Innova 300 argon ion laser (see FIG. 5). The bleaching intensity used may be approximately 400 mW/cm². The absorption of the film is monitored using two probe beams at 488 nm and at 632.8 nm. The wavelength of the 488 nm probe beams monitors the peak absorption of dye in the film and the change in peak absorption is used to calculate the approximate index change of the film. The second probe beam from the HeNe is used to monitor the absorption tail and aids in the verification of the relation between the peak absorption and the residual absorption. The bleaching setup is illustrated FIG. 5. Ultem/DEDR1 films may take approximately 72 hours to photobleach and PMMA/DR1 waveguides may take approximately 572 hours.

In step 416, method 400 anneals the waveguides on a hotplate to relieve stresses induced during the photobleaching process of step 414. In one example of step 416, the PMMA/DR1 and the Ultem/DEDR1 waveguides are annealed at 110 degrees C. These bleaching times may be large compared to other reported results due to the reduction of oxygen flow to the sample during bleaching caused by the contact mask and the s-polarized bleaching radiation from the laser. From previous studies it is clear that oxygen plays an important part in the photobleaching rate. If the oxygen is cutoff from the process there will be a slight change in the absorption of the film due the new photostationary state established in the film and a new polarization dependent index will be formed in the material due to the reorientation of the dye molecules, but photobleaching will not occur. The use of s-polarized radiation will also increase the time required to photobleaching the film due since the dipole moment of the dye molecule must be oriented along the polarization vector of the incident bleaching field in order for the reaction to occur.

In step 418, method 400 forms the waveguide endfaces. In one example of step 418, after the waveguides are bleached into the film, the waveguide endfaces are formed by cleaving the substrate. The cleaving process is performed by scratching the glass substrate with a diamond scribe and then placing the substrate between two plates such that the scratch in the substrate surface is aligned with the edge of the plates. Pressure is then applied to the substrate which cleaves leaving a smooth low loss endface on the waveguides. Waveguides are then tested for loss and mode shape.

An important aspect of getting good endface quality using the cleaving process is the adhesion between the polymer film and the glass substrate. Cleaving experiments performed with Ultem/DEDR1 films and PMMA/DR1 films have shown that significant peeling of the film occurs at the cleaving interface when the substrates are not cleaned thoroughly which results in poor adhesion of the film. Even with high quality substrates peeling problems were still apparent with the Ultem/DEDR1 films. An adhesion layer should probably be coated over the glass before spinning the Ultem/DEDR1.

FIG. 5 shows one exemplary setup 500 for bleaching waveguides in PMMA/DR1 and Ultem/DEDR1. A detector 502 is used to monitor helium neon (HeNe) probe beam 506 that is redirected by mirror 504 after being generated by a HeNe beam generator 508. A bleaching beam 514 is generated by an argon ion laser 518 and reflected by mirror 516 through microscope objective 512 onto a second detector 510. Detector 510 is used to monitor bleaching beam 514. See section 5.2 of provisional '411.

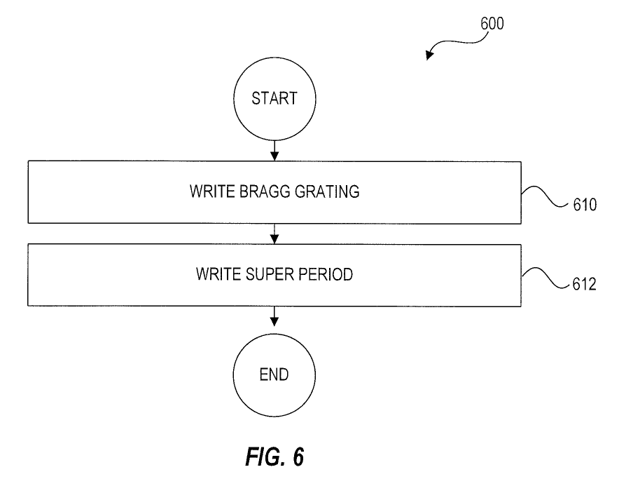

FIG. 6 is a flowchart illustrating one exemplary method 600 for slow light grating fabrication. In method 600, a Moiré grating is fabricated. In step 610, method 600 holographically writes a Bragg grating into the waveguides using irreversible photobleaching. The setup (shown in FIG. 7) uses the 514 nm line of the argon ion laser which is the line with the most power and it is close enough to the absorption peak of both DEDR1 and DR1 to photobleach them. The period of the grating, λ, is related to the half angle between the two beams, θ, through the relation,

$$Λ = \frac{{λ}_{bleach}}{2 sin ( θ )} \qquad ( 1 )$$

The half angle between the two beams is related to the Bragg wavelength in the waveguide through the following relation,

$$θ = {sin}^{- 1} ( \frac{{n}_{eff} {λ}_{bleach}}{{λ}_{Bragg}} ) \qquad ( 1 )$$

where n_{eff} is the effective index of the guide, Λ_{bleach} is the bleaching wavelength and Λ_{Bragg} is the Bragg wavelength in the guide.

The grating in the waveguide is tuned to the proper wavelength by first using a substrate with unbleached PMMA/DR1 and illuminating it with the interference pattern for the grating for 1 minute using a two low intensity beams with intensities of approximately 50 mW/cm² each. This forms a surface relief grating with the same period that can be quickly erased by heating the substrate close to the glass transition temperature or by illumination with circularly polarized light. The diffraction off of the surface relief grating is measured to determine the period of the grating. The surface relief effect was measured with an atomic force microscope (AFM). When the correct period is generated the waveguide is placed into the setup and the grating is irreversibly photobleached into the waveguide. The other waveguides on the substrate are protected from the photobleaching radiation with a rectangular contact mask made out of aluminum foil that is positioned over the polymer surface before photobleaching process begins. The temperature of the PMMA/DR1 and Ultem/DEDR1 films was raised from 80 degrees C. to 100 degrees C. by passing current through an ITO coated slide that the waveguide was mounted to. This was done to relieve stresses induced into the film during the photobleaching process. A photobleaching model for PMMA/DR1 and Ultem/DEDR1 was used to determine the approximate bleaching time needed for the desired index contrast. The index contrast determines the width of the stop-band of the grating.

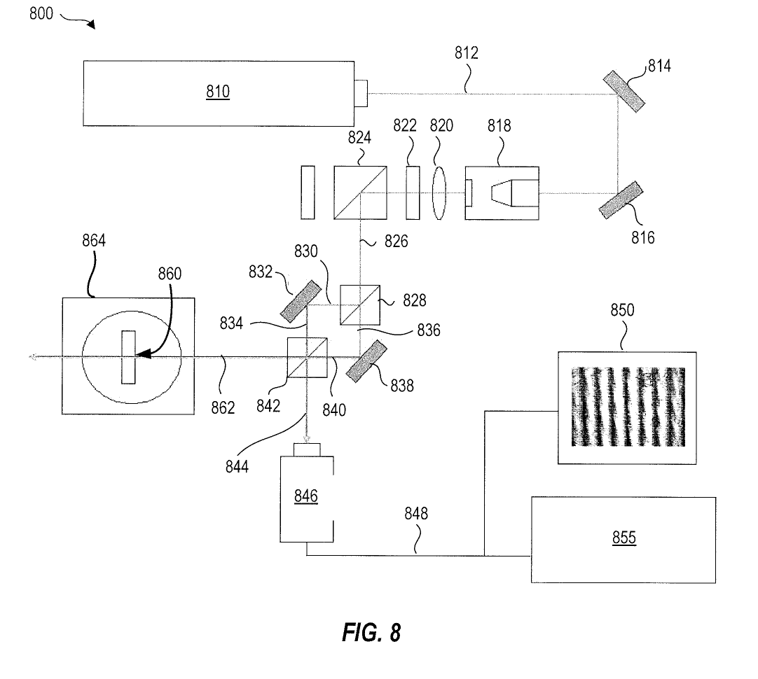

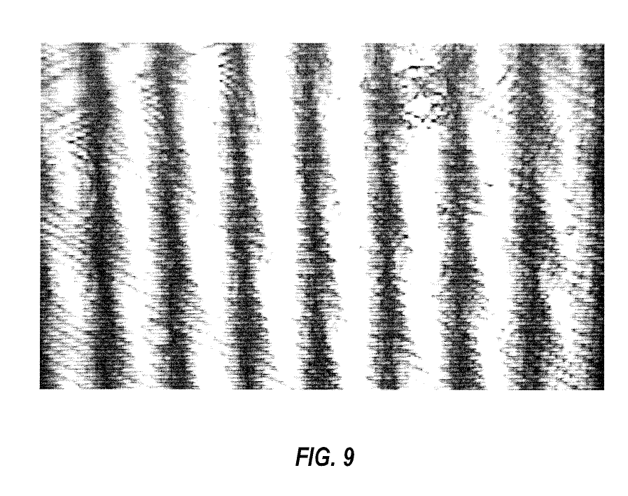

In step 612, after the initial Bragg grating is written and analyzed, method 600 photobleaches a second grating with a super period (e.g., much larger spacing) into the waveguide. In step 612, method 600 heats the waveguides in the same fashion as step 610 to relieve stresses induced during the photobleaching process. The super period grating spacing is fabricated using the interference generated by two beams with a slight spatial separation (see FIG. 8). The period of the interference pattern is visible and is measured using a Pulnix 545 camera. The period of the interference pattern is then measured using a computer program to verify the proper spacing. One exemplary interference pattern captured by the computer is shown in FIG. 9.

FIG. 7 shows one exemplary holographic photobleaching setup 700 for creating Bragg gratings. A HeNe beam generator 708 generates helium neon (HeNe) probe beam 606 which is redirected by mirror 704 onto device surface 750. A detector 702 is used to monitor HeNe probe beam 706. An argon ion laser 710 generates a bleaching beam 712 that is redirected by mirrors 714 and 716 onto SF1 718. The beam travels through SF1 718, a lens 720, and HWP 722 onto beam splitter 724 where it is split into two separate beams 726 and 732. Beam 726 travels through HWP 728 and is redirected by mirror 730 onto device surface 750. Beam 732 is redirected by mirror 734 onto the surface of the device. A temperature control device 736 monitors and controls the temperature through a connection 738 to a transition/rotation stage 740. A computer 745 may control and monitor temperature control device 736 via connection 742. Similarly, computer 745 may control and monitor detector 702 via connection 744. Computer 745 may be running software for use on the PC Labview program.

FIG. 8 shows one exemplary setup 800 for photobleaching the super period. The generation of the super period grating is difficult to control with setup 800 (as shown) because the adjustment of the beams interfering off of the beam splitter only has a course control and thus the measurement accuracy of the grating period is approximately 0.1 mm. This system may, however, be improved by adding a fine adjustment to the beam control (not shown) and magnifying the interference fringes on the camera. This improves the resolution of the period measurement.

An argon ion laser 810 generates a bleaching beam 812 that is redirected by mirrors 814 and 816 onto SF1 818. The beam travels through SF1 818, a lens 820, and HWP 722 onto beam splitter 824. Beam 826 is split by beam splitter 828 into beam 830 and beam 836. Beam 830 is redirected by mirror 832 onto another beam splitter 842. Similarly, beam 836 is redirected by mirror 838 onto beam splitter 842. Splitter 842 combines incoming beams with a slight spatial separation and divides them into beams 862 and 844. Beam 862 is directed onto the device surface 860. The grating on device surface 860 is fabricated using the beam 862 which is the combination of two beams with slight spatial separation. Beam 844 (same as beam 862) is directed onto a camera 846. Camera 846 may be, for example a Pulnix 545 camera. Camera 846 may be controlled and monitored via line 848 which connects to monitor 850 and computer 855. See provisional '411.

As discussed above, FIG. 9 shows one exemplary interference pattern used to modulate the super period grating in dye-doped polymer waveguide.

Since certain changes may be made in the above methods and systems without departing from the scope of the disclosure herein, one intention is that all matter contained in the above description or shown in the accompanying drawings be interpreted as illustrative and not in a limiting sense. By way of example, those skilled in the art should appreciate that the submicron structures in dye-doped polymer materials described herein may be constructed, connected, arranged, and/or combined in ways that are equivalent to what is shown.

What is claimed is:

1. A nonlinear dye-doped polymer optical rectification detector comprising:
optical input for receiving a modulated optical carrier signal;
optical structure for conveying the modulated optical carrier through the detector; and
electrical structure overlaid with the optical structure arranged to optimize matching between electrical and optical waves and to enhance the second order nonlinearity of polymer in the detector.

2. The optical rectification detector of claim 1, the efficiency of the detector increasing as the frequency of the optical carrier signal increases.

3. A method of manufacturing a dye-doped polymer optical rectification detector, comprising:
forming a cladding layer on a substrate;
forming a nonlinear polymer layer on the cladding layer;
photobleaching waveguides into the polymer layer;
annealing after the step of photobleaching to relieve stress in the nonlinear polymer layer;
forming a top cladding layer onto the nonlinear polymer layer;
depositing a metal layer onto the top cladding layer;
etching coplanar waveguides into the metal layer;
heating the optical rectification detector;
applying a poling voltage to electrodes formed on the metal layer for a period determined by monitoring the poling current; and
forming waveguide endfaces for interfacing to an optical carrier signal.

4. The method of claim 3, wherein one or more of the cladding layer, the nonlinear polymer layer and the top cladding layer are formed by a spinning deposition technique.

5. A method for reducing the group velocity of light in a dye-doped polymer optical rectification detector, comprising:
writing a Bragg grating holographically into one or more waveguides of the detector;
writing a super period holographically into the waveguides using irreversible photobleaching to form a Moiré grating; and
annealing the polymer of the detector in-situ to reduce stresses induced from altering the submicron structure of the grating.

6. The method of claim 5, wherein the slowing factor ranges from 1.25 to 2.6 in the resulting Moiré grating.

7. A method for planar waveguide fabrication, comprising:
depositing a thin dye-doped polymer film onto a substrate;
photobleaching one or more waveguides into the thin dye-doped polymer film;
annealing the one or more waveguides to relieve stresses induced during the photobleaching process; and
forming endfaces by cleaving the substrate.
